(19) United States
(12) Patent Application Publication
(10) Pub. No.: US 2012/0155239 A1
(43) Pub. Date: Jun. 21, 2012

(54) CHANNEL CIRCUIT AND METHOD OF DETECTING DEFECT OF MAGNETIC DISK DRIVE

(75) Inventors: Masatsugu NISHIDA, Tokyo (JP); Nobuhiro MAETO, Tokyo (JP); Akihiro YAMAZAKI, Kanagawa (JP)

(73) Assignee: Kabushiki Kaisha Toshiba, Tokyo (JP)

(21) Appl. No.: 13/240,529

(22) Filed: Sep. 22, 2011

(30) Foreign Application Priority Data
Dec. 17, 2010 (JP) P2010-282155

(51) Int. Cl. G11B 20/18

(52) U.S. Cl. 369/53.44; G9B/20.046

(57) ABSTRACT

A channel circuit includes: a detecting module configured to sample a signal amplitude of a reproduced signal of a single-frequency pattern written on a medium, and to detect an amplitude change that is lower or higher than a threshold; and a judgement module configured to judge whether the reproduced signal is decodable by a decoding circuit or not based on a result of detection by the detecting module.

### CROSS REFERENCE TO RELATED APPLICATION(S)

The present disclosure relates to the subject matters contained in Japanese Patent Application No. 2010-282155 filed on Dec. 17, 2010, which are incorporated herein by reference in its entirety.

### FIELD

An embodiment of the present invention relates to a channel circuit and a method of detecting a defect of a magnetic disk drive.

### BACKGROUND

In defect detection owing to defect scan (see JP-A-11-161907, for instance) of a magnetic disk drive, an adequate threshold according to a balance with the signal amplitude must be set in order to prevent excessive detection and erroneous detection from occurring. In the case where the characteristic of apparatuses, heads and medias varies widely, however, it is difficult to set a single threshold which is adequate to all defects. Therefore, a threshold should be set as a value for an average signal amplitude, and omission of defect detection is to be judged based on an actual read operation. When this method is employed, however, two operations, i.e., a Write/Read operation for defect scan, and that for Low Density Parity Check (LDPC) decoding are required, and the defect detection time in manufacturing process is doubled.

It has been requested to develop a technique for shortening the defect detection time. However, how to satisfy the request is unknown.

### BRIEF DESCRIPTION OF THE DRAWINGS

A general configuration that implements the various features of the invention will be described with reference to the drawings. The drawings and the associated descriptions are provided to illustrate embodiments of the invention and should not limit the scope of the invention.

FIG. 1 is an exemplary block diagram illustrating the configuration of a disk drive of an exemplary embodiment of the invention.

FIG. 2 is an exemplary circuit block diagram showing in detail a part of the embodiment.

FIG. 3 is an exemplary block diagram of an encoder and a decoder of the embodiment.

FIG. 4 is an illustrative view showing an example of permutation and coupling when a number of parity bit 0 is larger than a number of parity bit 1, in the embodiment.

### DETAILED DESCRIPTION OF THE EMBODIMENTS

According to one embodiment, there is provided a channel circuit including: a detecting module configured to sample a signal amplitude of a reproduced signal of a single-frequency pattern written on a medium, and to detect an amplitude change that is lower or higher than a threshold; and a judgement module configured to judge whether the reproduced signal is decodable by a decoding circuit or not based on a result of detection by the detecting module.

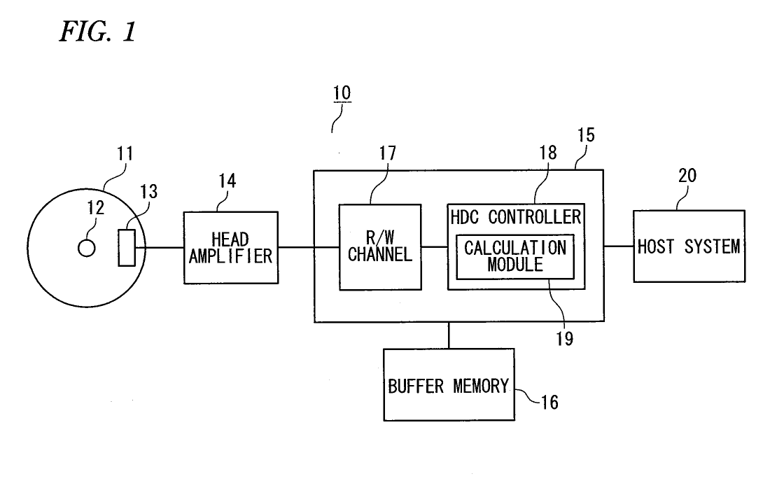

Hereinafter, an embodiment of the invention will be described with reference to FIGS. 1 to 4.

### [Configuration of Disk Dive]

FIG. 1 is an exemplary block diagram illustrating the configuration of an exemplary embodiment of the invention. As shown in FIG. 1, a disk drive 10 of the embodiment has a disk 11 which is a magnetic storage medium, a spindle motor 12, a head 13, a head amplifier 14, a system-on-chip (SOC) 15, and a buffer memory 16. The spindle motor 12 rotates the disk 11. The head 13 includes a read head element and a write head element, and reads or writes data from or to the disk 11.

The head amplifier 14 amplifies a signal (read data) which is read by the head 13, and transmits the amplified data to the system-on-chip 15. Furthermore, the head amplifier 14 converts a signal (write data) which is output from the system-on-chip 15, into a write current, and transmits the current to the head 13.

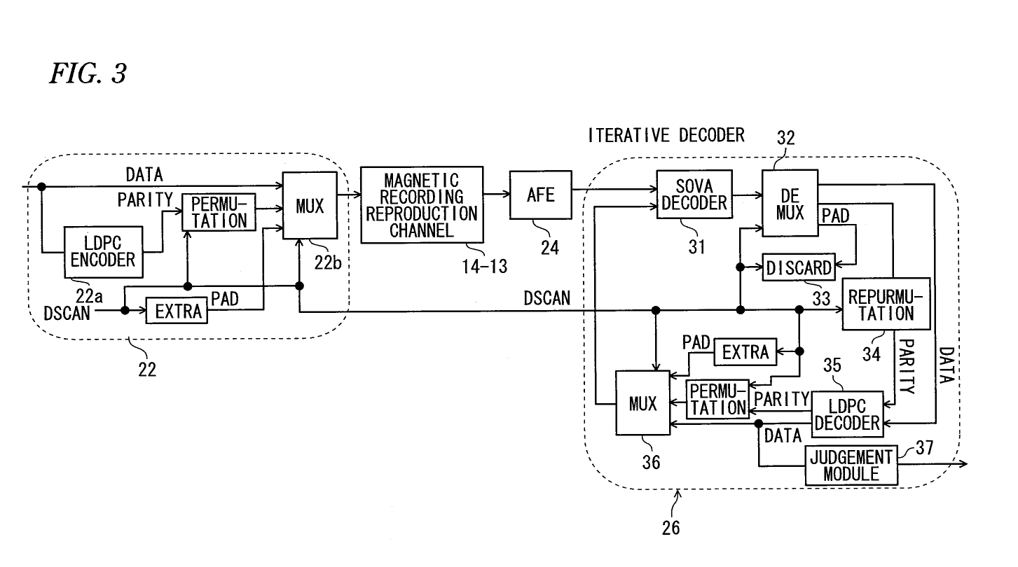

The system-on-chip 15 includes a read/write (R/W) channel 17 and a hard disk controller (HDC, hereinafter refereed to simply as a controller). The R/W channel 17 is a signal processing circuit for recording and reproducing data, and has functions of decoding data which are read by the head 13, and encoding write data. Main components of FIG. 3 which are described later are in the system-on-chip 15.

A controller 18 is an interface to control data transfer between the R/W channel 17 and a host system 20 using the buffer memory 16. The controller 18 controls data recording/reproducing operations via the R/W channel 17, and performs a data reconstruction process related to the embodiment. The controller 18 includes an XOR calculation module 19 which is necessary in, for example, the data reconstruction process.

The buffer memory 16 is controlled by the controller 18, and temporarily stores read data and write data. The host system 20 is configured by digital apparatuses which use the disk drive 10 as an external storage apparatus, such as a personal computer and a digital television receiver.

A read channel of a magnetic disk apparatus has a function of defect scan, and includes a circuit which detects a variation such as an amplitude drop.

The manufacturer of a magnetic disk apparatus uses the function to detect an initial defect of a magnetic disk in a manufacturing process, and registers it in a defect list.

In the defect scan, a data pattern with a single frequency (refereed to simply as a single-frequency pattern) is written in a track to be checked on a media, and the read channel is set to a defect scan mode, and a reading operation is performed. When an amplitude change that is lower or higher than the preset-threshold is detected, a flag is informed to the controller, and a position indication such as the sector number is recorded in the memory. In the defect scan, as described above, it is possible to detect a variation of the signal amplitude which is caused by a lack of a magnetic film due to a surface asperity formed mainly during the disk production.

Generally, a pattern in which the timing of magnetization reversal corresponds to 2T, as in 11001100 . . . (usually, called a 2T pattern) is used. However, the method is not limited to this.

In defect detection owing to defect scan, an adequate threshold according to a balance with the signal amplitude must be set in order to prevent excessive detection and erroneous detection from occurring. In the case where the characteristic of apparatuses, heads and medias varies widely, however, it is difficult to set a single threshold which is adequate to all defects. Therefore, a threshold should be set as a value for an average signal amplitude, and omission of defect detection must be judged based on an actual read operation. However, a single-frequency pattern which is written on a medium in order to perform defect scan cannot be read by an LDPC decoder. Consequently, two operations, i.e., a write/read operation for defect scan, and that for LDPC decoding are required, and the check time in manufacturing process is doubled.

In a related technique, while writing random data on a medium, a drop of the signal amplitude in digital data such as FIR output is checked, and determination is performed in conjunction with a result of a correction by LDPC. In the method, random data are to be written on a medium, and hence there is no guarantee that a defect will be correctly detected, as compared with the defect scan function checking by a single-frequency pattern.

In the embodiment, in order to deal with the problem, a check matrix for defect scan which enables to decode with LDPC even if a data is a single frequency pattern is prepared. While detecting a defect of a single-frequency pattern, therefore, it is possible also to judge whether a corresponding sector is decodable by LDPC or not. In the embodiment, furthermore, a defect detecting step in the manufacturing process of a magnetic disk drive has: a first detecting module registering, as a defect, a sector which is detected by the defect scan, and a second detecting module registering, as a defect, a sector which cannot be reproduced with LDPC decoding circuit.

Usually, a parity bit array which is generated when encoding a single-frequency pattern such as 11001100 . . . is not a single-frequency pattern, and each bit of the generated parity bit array is inserted into data. Therefore, data of a single-frequency pattern are not written on a medium.

In the embodiment which will be described below, a special mode is prepared in addition to a usual mode, each bit of the generated parity bit array is not inserted into data, but permuted so as to be same single-frequency pattern as the data, and coupled with the end of the data to generate data of a single-frequency pattern, and the generated data are written on a medium. The permuted parity bit array is coupled with the end of the data in the embodiment. Alternatively, the permuted parity bit array may be coupled with the top of the data, or inserted into data in unit of one period (in the above example, in unit of four bits of 1100).

In reproduction, the manners of coupling and permutation are already known, hence the parity bit array is re-permuted into the original bit array, and the reproduced data are decoded with LDPC to be reproduced.

When the number of parity bit 0 is not equal to that of parity bit 1, the parity bit array cannot be permuted into a single-frequency pattern. The embodiment is configured so that, in this case, extra bits are added so as to attain the same numbers. In decoding, the extra bits are discarded because the position where they are added is already known.

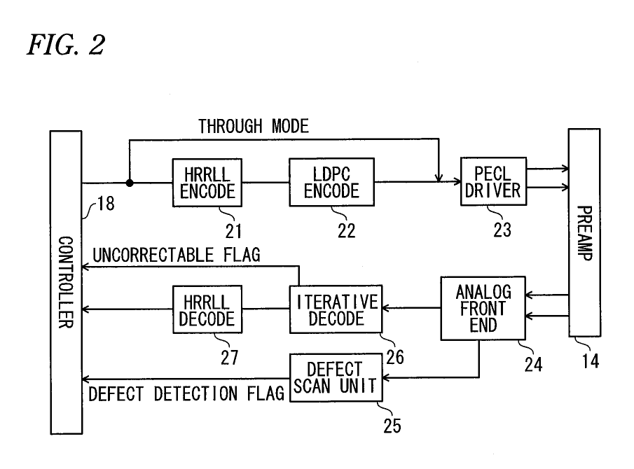

FIG. 2 is an exemplary schematic block diagram of the read/write (R/W) channel 17. The output of the controller 18 is guided to an HRRLL encoder 21, and the output of the HRRLL encoder 21 is guided to an LDPC encoder 22. The output of the LDPC encoder 22 is guided to a PECL driver 23. The output of the PECL driver 23 is guided to the head amplifier 14.

In contrast to the thus configured write channel, in the read channel, the output of the head amplifier 14 is guided to an analog front end 24, and the output of the analog front end 24 is guided to a defect scan circuit 25 and iterative decoder 26 which will be described later. The output of the iterative decoder 26 is guided to an HRRLL decoder 27, and the outputs of the HRRLL decoder 27 and the defect scan circuit 25 are guided to the controller 18.

In a through mode which will be described later, it is configured so that the output of the controller 18 is guided to the PECL driver 23. Furthermore, it is configured so that a determination signal indicating whether a sector to be processed can be reproduced or not is sent from the iterative decoder 26 to the controller 18.

The read/write channel is configured so that, when a DSCAN mode is set by the controller 18, the HRRLL encoder 21 is disabled, and data (11001100 . . . ) sent from the controller are input to the LDPC encoder 22.

FIG. 3 is an exemplary block diagram showing an encoder and a decoder in more detail. The parity is generated from data by the LDPC encoder 22.

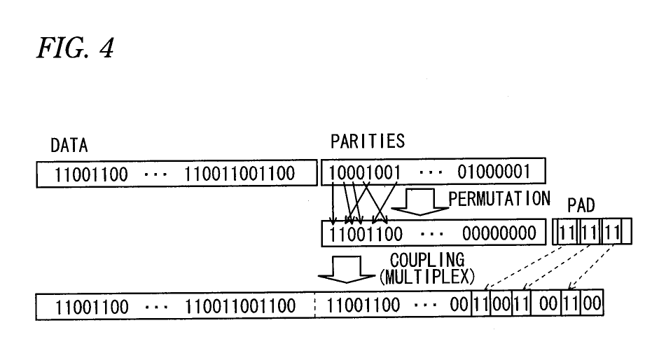

As shown in FIG. 4, next, the parity bit array is permuted so as to be the same period as the data. In the case where the number of parity bit 0 is not equal to that of parity bit 1, the surplus bits are arranged in the end. FIG. 4 shows an example in which the number of parity bit 0 is larger and that of parity bit 1 is smaller. Next, the data and the parity are coupled to each other by a multiplexer 22b. When the number of parity bit 0 is not equal to that of parity bit 1, extra pad bits are inserted into the permuted parity bit array, and multiplexed so as to be the same period as the data. In the example shown in FIG. 4, six bits of parity bit 1 are prepared as extra pad bits, and inserted between 00s which are arranged in the end of the parity bit array, by the multiplexer 22b.

The single-frequency pattern which is generated as described above is written on a medium. Even when the pattern is not a single-frequency pattern which is encoded and generated in the DSCAN mode, it is seen that the pattern eventually results in a single-frequency pattern. Therefore, a coding circuit may be bypassed, and the single-frequency pattern may be directly written on the medium.

Next, the signal which is written on the medium is reproduced. The reproduced signal is analog signal processed by an analog frond end (AFE) 24. One signal is sent to the defect scan circuit 25 where an amplitude drop and the like are detected. The other signal is supplied to the iterative decoder 26. First, the signal is passed through a Soft Output Viterbi Algorithm (SOVA) decoder 31, and then separated by a demultiplexer 32 into data, parities, and extra pad bits. The extra pad bits are discarded. The parities are permuted into the original sequence, and then supplied together with the data to an LDPC decoder 35 to be decoded by LDPC. Moreover, the data, the permuted parity bit array, and the extra pad bits are coupled to one another by a multiplexer 36, and the coupled data is supplied to the SOVA decoder 31. Iterative decoding is performed in this way, and finally the determination signal indicating whether the sector can be reproduced or not is sent to the controller. The controller detects a defect from results of the two means, i.e., the defect scan circuit 25 and the iterative decoder 26.

A defect due to amplitude variation which is caused by, for example, a surface flaw of a medium, and whether reproduction can be performed by an actual decoding circuit or not can be simultaneously checked by the means which have been described in the embodiment, and the time consumed for a defect detection time can be shortened by the following configurations.

(1) A read channel circuit characterized in that the circuit has: a module which writes a single-frequency pattern on a medium, which samples the signal amplitude of a reproduced signal therefrom, and which detects an amplitude change that is lower or higher than a threshold; and a module which can judge simultaneously whether the reproduced signal is decodable with a decoding circuit or not.

(2) A read channel circuit of above (1) characterized in that the circuit has a module which permutes the parity bit array that is generated when encoding data of a single-frequency pattern, so as to be a single-frequency pattern, and which writes the rearranged parities on a disk.

(3) A read channel circuit of above (2) characterized in that, when a numbers of parity bit 0 is not equal to a numbers of parity bit 1, an addition of extra bits is performed to form a single-frequency pattern.

(4) A read channel circuit of above (1) characterized in that, during reproduction of the data of single-frequency pattern, data corresponding to the parity bit array is rearranged, extra bits are discarded, and data are decoded.

(5) A method of detecting a defect of a magnetic disk drive wherein a first module which has the read channel circuit of above (1), and which registers, as a defect, a sector where an amplitude change is detected, and at the same time a second module which decodes a reproduced signal by means a decoding circuit, and which registers an unreproducible sector as a defect are used.

The invention is not limited to the above-described embodiment, and, in addition, the invention can be embodied while being variously modified without departing the spirit of the invention.

By appropriate combinations of plural components disclosed in the embodiment, various inventions can be configured. For example, some of the components can be omitted from all of the components shown in the embodiment. Moreover, the components in different embodiments can be appropriately combined.

What is claimed is:

1. A channel circuit comprising:
a detecting module configured to sample an amplitude of a reproduced signal of a single-frequency pattern written on a medium, and to detect an amplitude change that is lower or higher than a threshold; and
a judgement module configured to judge whether the reproduced signal is decodable by a decoding circuit or not based on a result of detection by the detecting module.

2. The channel circuit according to claim 1, further comprising:
a writing module configured to permute a parity bit array that is generated when encoding data of a single-frequency pattern, so as to be the same frequency as the data, and to write the permuted parity bit array on the medium.

3. The channel circuit according to claim 2, wherein, when a number of parity bit 0 is not equal to a number of parity bit 1 of the parity bit array, the writing module is configured to add extra bit to form the single-frequency pattern.

4. The channel circuit according to claim 1, further comprising a reading module configured to perform, on the reproduced signal, rearranging of data corresponding to bit of the parity bit array and discarding of extra bit, and to decode data.

5. A method of detecting a defect of a magnetic disk drive, wherein the magnetic disk drive comprising a channel circuit according to claim 1,
wherein the method comprises:
registering, as a defect, a sector where an amplitude change is detected, and registering an unreproducible sector as a defect.
